(19) United States
(12) Patent Application Publication
(10) Pub. No.: US 2006/0005112 A1
(43) Pub. Date: Jan. 5, 2006

(54) System and method of report layout

(76) Inventors: David Lilly, Kanata (CA); Eric McCully, Gloucester (CA); Roger Chang, Ottawa (CA)

Correspondence Address: SHUMAKER & SIEFFERT, P. A., 8425 SEASONS PARKWAY, SUITE 105, ST. PAUL, MN, 55125, US

(21) Appl. No.: 10/884,012

(22) Filed: Jul. 2, 2004

(51) Int. Cl. G06F 15/00; G06F 17/00

(52) U.S. Cl. 715/500; 715/764; 715/505; 715/509; 707/104.1

(57) ABSTRACT

A conditional layout system for rendering and formatting content in a report is provided. The conditional layout system comprises an element receiving unit for receiving a variable element referenced in a report element, a condition processing unit for calculating a condition value based upon an expression in the variable element, and an element rendering unit for conditionally rendering and formatting report elements based upon the condition value.

### FIELD OF THE INVENTION

The invention relates generally to reporting tools, and in particular to a system and method of report layout.

### BACKGROUND OF THE INVENTION

Business intelligence (BI) systems are gaining wide acceptance as a way of displaying business information from gathered data stored in databases such as a data warehouse. In a BI system, end users will typically receive information in the form of reports.

Reporting of business intelligence (BI) is the process of accessing, formatting, and delivering stored, collected and processed data. Reporting helps business people understand their company performance. It lets them take action on the information.

Reporting provides high-performance engines to merge predefined report templates with large volumes of data to produce, publish and distribute reports to a wide audience of information consumers. Key reporting features for reporting include advanced formatting, multi-pass calculations, bursting, table of contents navigation, on-demand paging, report element security and output to multiple formats (for example, portable document format (PDF), hypertext markup language (HTML), and spreadsheet applications).

When a report is generated, it is common to retrieve the data from different databases, aggregate them and display the data in a report. It is also common to set a format style to the data to be presented in a report. It is often desirable to highlight or emphasise some content of a report. In the past, a user would have to code a condition in a report generation application and associate that condition with a feature that highlights the information. Thus, a user needs to have programming ability to code the condition in the report generation application. Moreover, this solution was only available for Boolean expressions.

There is a need in the art for a method of formatting a report for complex expressions.

### SUMMARY OF THE INVENTION

It is an object of the present invention to provide a method of conditional formatting of a report.

In accordance with an embodiment of the present invention, there is provided a conditional layout system for rendering and formatting content in a report. The conditional layout system comprises an element receiving unit for receiving a variable element referenced in a report element, a condition processing unit for calculating a condition value based upon an expression in the variable element, and an element rendering unit for conditionally rendering and formatting report elements based upon the condition value.

In accordance with another embodiment of the present invention, there is provided a method of laying out a report. The method comprises the steps of obtaining a variable element referenced in an element of a report, calculating an expression value based upon an expression in the variable element, and conditionally rendering and formatting report elements based upon the expression value.

In accordance with another embodiment of the present invention, there is provided a computer data signal embodied in a carrier wave and representing sequences of instructions which, when executed by a processor, cause the processor to perform a method of laying out a report. The method comprises the steps of obtaining a variable element referenced in an element of a report, calculating an expression value based upon an expression in the variable element, and conditionally rendering and formatting report elements based upon the expression value.

In accordance with another embodiment of the present invention, there is provided a computer-readable medium having computer readable code embodied therein for use in the execution in a computer of a method of laying out a report. The method comprises the steps of obtaining a variable element referenced in an element of a report, calculating an expression value based upon an expression in the variable element, and conditionally rendering and formatting report elements based upon the expression value.

In accordance with another embodiment of the present invention, there is provided a computer program product for use in the execution in a computer of a conditional layout system for rendering and formatting content in a report. The computer program product comprises an element receiving unit for receiving a variable element referenced in a report element, a condition processing unit for calculating an expression value based upon an expression in the variable element, and an element rendering unit for conditionally rendering and formatting report elements based upon the expression value.

### BRIEF DESCRIPTION OF THE DRAWINGS

FIG. 1 provides a general overview of how a report output page is typically generated.

FIG. 2 shows an example of a report layout data model, in accordance with an embodiment of the present invention.

FIG. 3 shows another example of a report layout data model, in accordance with an embodiment of the present invention.

FIG. 4 shows an example of a conditional layout system for laying out content in a report, in accordance with an embodiment of the present invention.

FIG. 5 show in a flowchart an example of a method of laying out a report, in accordance with an embodiment of the conditional layout system.

FIG. 6 shows in a flowchart another example of a method of laying out a report a report, in accordance with an embodiment of the conditional layout system.

FIG. 7 shows in a flowchart another example of a method of laying out a report a report, in accordance with an embodiment of the conditional layout system.

FIG. 8 shows an example of a report layout user interface module of a conditional layout system.

FIG. 9 shows an example of a conditional style dialog unit, in accordance with an embodiment of the user interface module.

FIG. 10 shows an example of a variable dialog unit, in accordance with an embodiment of the user interface module.

FIG. 11 shows an example of an expression editing unit, in accordance with an embodiment of the user interface module.

FIG. 12 shows an example of a conditional explorer unit, in accordance with an embodiment of the conditional layout user interface system.

FIG. 13 shows another example of a conditional layout system, in accordance with an embodiment of the present invention.

FIG. 14 shows in a flowchart another example of a method of laying out a report, in accordance with an embodiment of the conditional layout system.

FIG. 15 shows in a screenshot an implementation of a user interface module of a conditional layout system.

FIG. 16 shows in a screenshot the properties selections of an example of a report element.

FIG. 17 shows in a screenshot an example of a conditional style dialog unit, in accordance with an embodiment of the conditional layout system.

FIG. 18 shows in a screenshot an example of an Add dialog, in accordance with an embodiment of the variable dialog unit.

FIG. 19 shows in a screenshot an example of a name and type selection of an embodiment of the variable dialog unit.

FIG. 20 shows in a screenshot an example of a Layout Expression dialog, in accordance with an embodiment of the expression editing unit.

FIG. 21 shows in a screenshot an example of a variables dialog, in accordance with an embodiment of the variable dialog unit.

FIG. 22 shows in a screenshot an example of a conditional style dialog, in accordance with an embodiment of the conditional explorer unit.

FIG. 23 shows in a screenshot an example of a display of an implementation of a conditional explorer unit, in accordance with an embodiment of the conditional layout system.

FIG. 24 shows in a screenshot an example of a display of conditional format element format styles of a report element, in accordance with an embodiment of the conditional layout system.

FIG. 25 shows in a screenshot an example of a Background Color dialog, in accordance with an embodiment of a conditional explorer unit.

FIG. 26 shows in a screenshot an example of a display of the association of a condition value with a format style, in accordance with an embodiment of the conditional layout system.

FIG. 27 shows a display of a rendered report showing conditionally formatted text, in accordance with an embodiment of the conditional layout system.

FIG. 28 shows in a screenshot an example of a Conditional Block dialog for Quantity corresponding with a conditional block element for quantity status, in accordance with an embodiment of the conditional layout system.

FIG. 29 shows in a screenshot an example of a block to be conditionally rendered, in accordance with an embodiment of the conditional layout system.

FIG. 30 shows in a screenshot an example of the output of a report.

FIG. 31 shows in a screenshot an example of a Conditional Style dialog, in accordance with an embodiment of the conditional layout system.

FIG. 32 shows in a screenshot an example of a Variables dialog for the QuantityStatus variable element.

FIG. 33 shows in a screenshot an example of a Layout Expression dialog 310, in accordance with an embodiment of the conditional layout system.

FIG. 34 shows in a screenshot an example of an association between the condition value Excellent and a format style of the Quantity report element, in accordance with an embodiment of the conditional layout system.

FIG. 35 shows in a screenshot the rendering of a report with the Quantity column conditionally formatted to the fonts associated with the condition values.

### DETAILED DESCRIPTION OF THE PREFERRED EMBODIMENTS

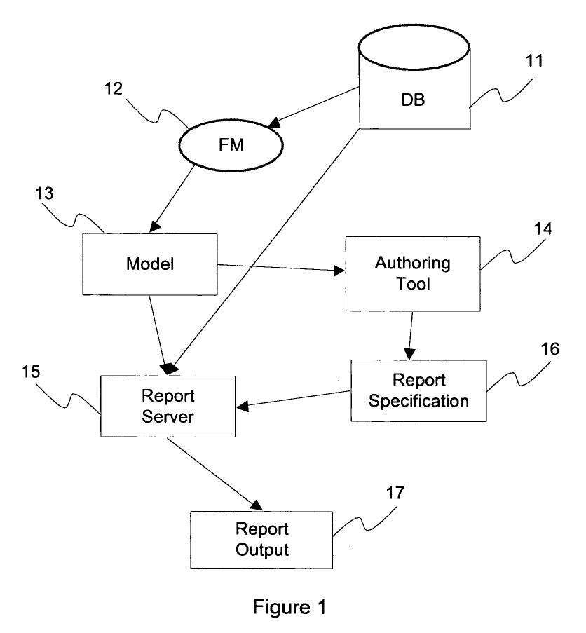

FIG. 1 provides a general overview of how a report output page is typically generated. Arrows indicate the direction of dataflow. The framework manager 12 reads structures of tables and columns in database 11, generates relationships between the tables, adds additional queries, calculations, conditions and run-time value prompts, and builds and publishes a model 13 comprising these definitions for consumption by an authoring tool 14 and report server 15. The authoring tool 14 uses the model 13 as a table of contents from which to build a report specification 16. The report server 15 uses the model 13 to generate queries (such as structured query language (SQL) and multidimensional expression (MDX) queries) from the report specification 16. The report specification 16 generated by the authoring tool 14 specifies how a report server 15 is executed to render one or more than one pages of report output 17. A rendering engine in a report server 15, for example, uses the model 13 to generate SQL and MDX queries from the report specification. These queries are executed against the database and data values are returned. Retrieved data values are formatted and arranged according to the layout definitions in the report specification 16, and then rendered to the user as pages of report output 17.

A report output can be one of, but not limited to: a printed paper page, a hypertext markup language (HTML) web page, a file encoded in a markup language for report output though a computer application, a page presented on a display or an encapsulated file types such as PostScript(™), or portable document format (PDF), etc.

Rendering is the process of utilizing the information stored in a database to produce the report output 17 from the authored report specification 16. The report specification can be considered as a template for the report output that defines everything that is needed to produce the report output except the data. Building this template is known as “authoring” the report specification. The rendering process merges this template with the data values returned from the database or repository in order to generate the desired report output.

A report may comprise a plurality of report elements. Rendering involves determining whether or not to include a report element in a report layout. Formatting or format styling involves controlling how a report element is displayed in the report, and is the presentation of the content of a given report item within a report layout. Typically, a format specification is defined for data rendered in a report. Format options for a report element may include any visual format that causes the report element to stand out from other report elements in the report. Possible format options include data formats (for example, setting decimals, currency, etc.), font properties, color, highlights, underscores, borders, patterns, justification, alignment, etc. In this respect, the style of a report may be altered. The content of a report may be determined when a report element is added or not added to a report. Therefore, content in a report may be conditionally determined and displayed.

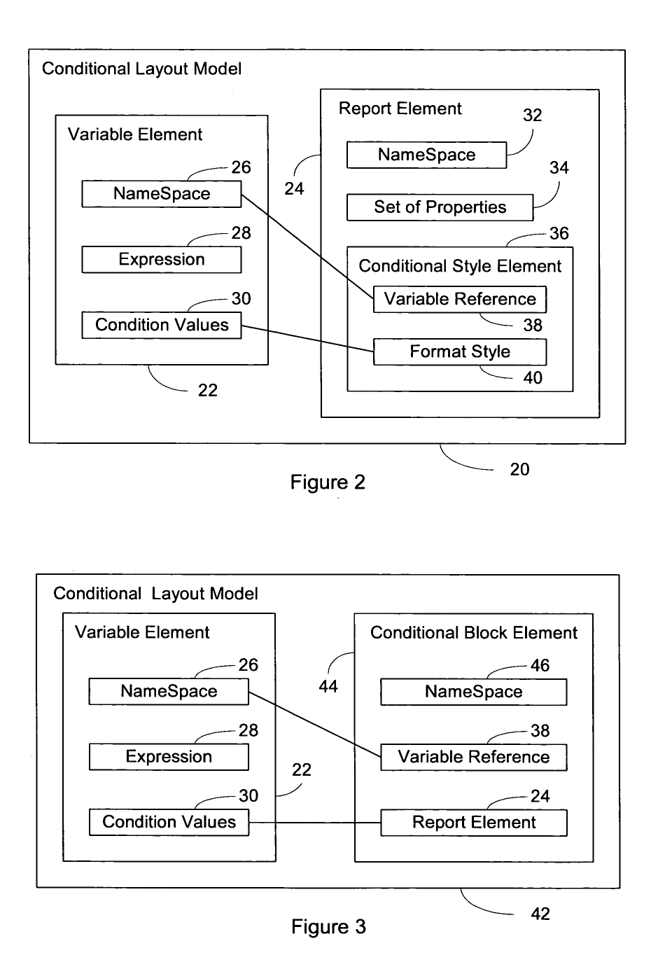

FIG. 2 shows an example of a conditional layout data model 20, in accordance with an embodiment of the present invention. The conditional layout data model 20 comprises one or more variable elements 22 for managing a condition expression and a set of values, and one or more report elements 24 for representing objects that can be added to a report. Each variable element 22 has a namespace 26 for allowing other elements to reference the variable element 22, an expression 28 for calculating a calculated value based upon a condition, and one or more condition values 30 to be associated with a format style 40 as described below. Each report element 24 comprises a namespace 32 for allowing other elements to reference the report element 24, a set of properties 34, and a conditional style element 36 for managing format styles of the report element 24. The conditional style element 36 has one or more format styles 40, each associated with a condition value 30, and a variable reference 38 to a namespace 26 of a variable element 22. Preferably, a conditional style element 36 further comprises a default format style to apply to the report element. Report elements 24 may comprise other elements including other report elements 24, and a conditional block element as described below. Each report element 24 may have different format styles 40 associated with condition values 30, and can reference different variable elements 22 having different expressions 28.

FIG. 3 shows another example of a conditional layout data model 42, in accordance with an embodiment of the present invention. The conditional layout data model 42 comprises one or more variable elements 22 as described above, and one or more conditional block elements 44 for holding objects that can be added to a report. A conditional block element 44 comprises a namespace 46 for referencing the conditional block element 44, a variable reference 38 to a namespace 26 of a variable element 22, and one or more report elements 24. Alternatively, the conditional block element 44 may comprise one or more report element references to a namespace 32 of a report element 24. The report elements 24, or report element references, are associated with a condition value 30. Each conditional block element 44 may have different report elements 24 associated with condition values 30, and can reference different variable elements 22 having different expressions 28.

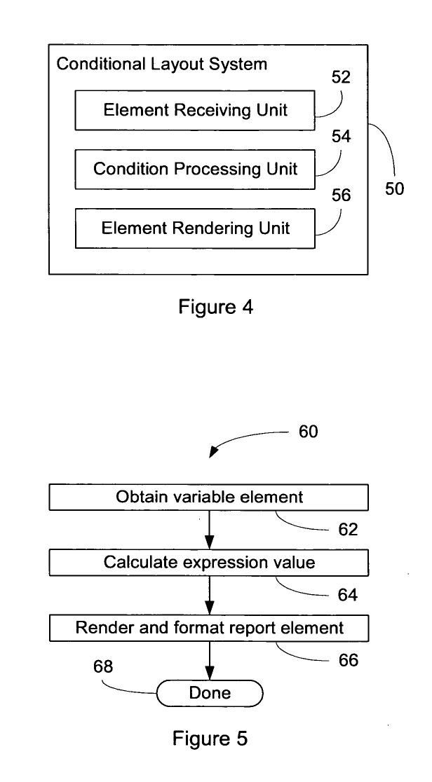

FIG. 4 shows an example of a conditional layout system 30 for laying out content in a report, in accordance with an embodiment of the present invention. The conditional layout system 50 comprises an element receiving unit 51 for receiving a variable element 22 referenced in a report element 24, a condition processing unit 54 for calculating an expression value based upon an expression 28 in the variable element 22, and an element rendering unit 56 for conditionally rendering and formatting the report element 24, based upon the expression value, into the report. Each unit 52, 54 and 56 may be code implemented in a report rendering application. Other units may be added to the system 50, including a user interface module, a formatting module for formatting the report element 24 in a format style 40 associated with the expression value, and a conditional rendering module for rendering a second report element 24 in a report, the second report element 24 associated with the expression value.

FIG. 5 shows in a flowchart an example of a method of laying out a report (60), in accordance with an embodiment of the conditional layout system 50. The method (60) begins with an element receiving unit 52 obtaining a variable element 22 (62) referenced in an element of a report. An expression value is then calculated (64) using an expression 28 in the variable element 22. The element rendering unit 56 then conditionally renders and formats the report element 24, based upon the condition value, into a report (66). The method (60) is done (68). There may be many report elements 24 in a report, and thus an entire report, may be conditionally laid-out using this method (60). Other steps may be added to this method, including receiving a request to render the report element 24, formatting the report element 24 in a format style 40 associated with the expression value, rendering a second report element 24 associated with the expression value in a report, and applying a default format style if no format style 40 is associated with the expression value.

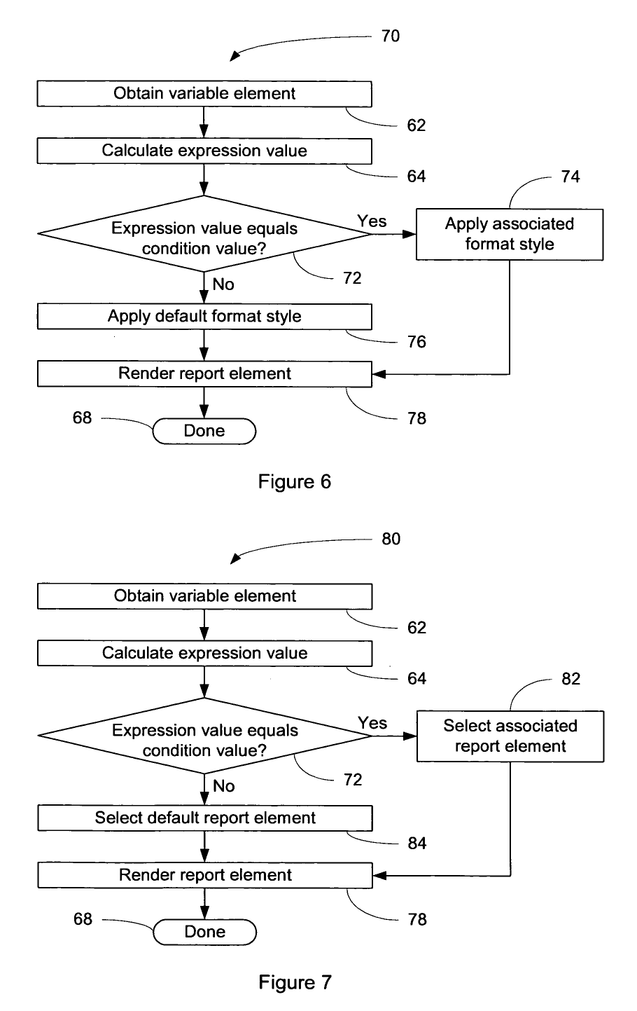

FIG. 6 shows in a flowchart another example of a method of laying out a report a report (70), in accordance with an embodiment of the conditional layout system 50. The method (70) begins with obtaining a variable element 22 (72) referenced in a report element 24. Next, an expression value is calculated (74) using an expression 28 of the variable element 22. If the expression value equals a condition value 30 (72) of the variable element 22, then the corresponding format style 40 associated with the condition value 30 is applied to the content of the report element 24 (74). Otherwise, a default format style is applied to the content of the report element 24 (76). Alternatively, the format of the content of the report element 24 is simply not changed. Once the format of the content of the report element 24 has been settled (74 or 76), the report element 24 is rendered (78), and the method (70) is done (68). In this manner, a multiplicity of report elements 24 may be conditionally formatted in a report. Other steps may be added to the method (70), including receiving a request to render the report element 24.

FIG. 7 shows in a flowchart another example of a method of laying out a report a report (80), in accordance with an embodiment of the conditional layout system 50. The method (80) begins with obtaining a variable element 22 (62) referenced in a conditional block element 44. Next, an expression value is calculated (64) using an expression 28 of the variable element 22. If the expression value equals a condition value 30 (72) of the variable element 22, then the corresponding report element 24 associated with the condition value 30 is selected (82). Otherwise, a default report element 24 is selected (84). Alternatively, no report element 24 may be selected. Once the selection of a report element 24 has been determined (82 or 84), the report element 24 is rendered (78), and the method (80) is done (68). In this manner, a multiplicity of report elements 24 may be conditionally rendered in a report. Other steps may be added to the method (70), including receiving a request to render the report element 24.

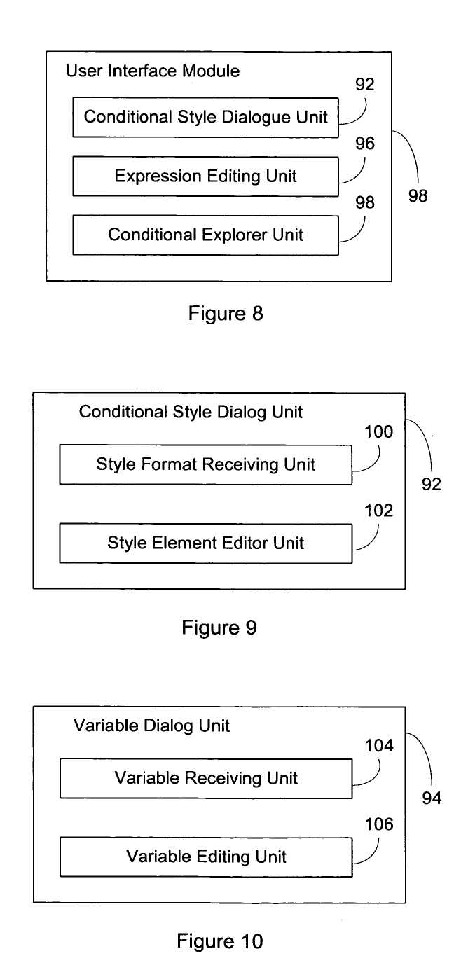

FIG. 8 shows an example of a conditional layout user interface module 90 of a conditional layout system 50. The user interface module 90 comprises a conditional style dialog unit 92 for managing a variable element 22 referenced in a conditional style element 36 or conditional block element 44, an expression editing unit 96 for managing an expression 28 of the variable element 22, and a conditional explorer unit 98 for associating condition values 30 of a variable element 22 with format styles 40 or report elements 24. Optionally, the user interface module 90 may further comprise an object selection unit for receiving a report element 24, a variable dialog unit for creating and managing variable elements 22 and associated condition values 30, and a repository for storing report elements 24 and variable elements 22.

FIG. 9 shows an example of a conditional style dialog unit 92, in accordance with an embodiment of the user interface module 90. The conditional style dialog unit 92 comprises a style format receiving unit 100 for receiving a condition value 30 of a variable element 22, and a style editing unit 102 for associating a format style 40 with the condition value 30. A user may operate the conditional style dialog unit 92 to select format styles 40 or report elements 24, and associate them with condition values 30. The style format receiving unit 100 receives the selections and passes them to the style editing unit 102 to update an association between a condition value 30 and a format style 40 or a report element 24. Optionally, the conditional style dialog unit 92 may further comprise a variable dialog unit for creating and managing variable elements 22 and their condition values 30, and a display unit for displaying the variable namespace 26 and condition values 30 of variable elements 22. The conditional style dialog unit 92 may comprise code corresponding to the above functionality such that the code is executable in a reporting application.

FIG. 10 shows an example of a variable dialog unit 94, in accordance with an embodiment of the user interface module 90 or conditional style dialog unit 92. The variable dialog unit 94 comprises a variable receiving unit 104 for receiving variable element 22 management instructions, and a variable editing unit 106 for creating and managing variable elements 22 in response to the variable element management instructions. In an embodiment of the variable dialog unit 94, variable type classifications include Boolean, language, and string. A user may use the variable dialog unit 94 to create, delete and edit variable elements 22. Using the variable dialog unit 94, a user may rename, and/or reclassify a variable element as a different type. Moreover, the variable dialog unit 94 may be used to create, delete and edit condition values 30. The variable receiving unit 104 receives the creation, deletion, and/or modification instructions from selections and passes them to the element editing unit 106 to update the variable element 22. Optionally, the variable dialog unit 94 may further comprise a display unit for displaying the variable element namespace 26, an associated condition or expression 28 for which to calculate an expression value, and format values 30 of the variable element 22. The variable dialog unit 94 may comprise code corresponding to the above functionality such that the code is executable in a reporting application. Preferably, the variable dialog unit 94 is implemented as a module of the conditional style dialog unit 92.

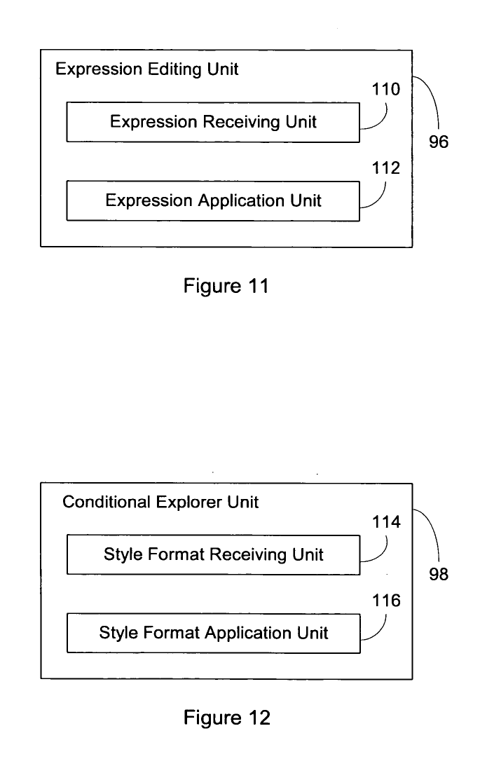

FIG. 11 shows an example of an expression editing unit 96, in accordance with an embodiment of the user interface module 90. The expression editing unit 96 comprises an expression receiving unit 110 for receiving a condition or expression 28 for which a format style 40 should be applied to a report element 15 or for which a report element 24 should be rendered in a report, and an expression application unit 112 for calculating an expression value. The expression application unit 112 may access many values or facts in context, such as the value of a column at the current row, the current data, the current rendering locale, etc. Some of these values may be found in the properties 34 of a report element 24. Optionally, the expression editing unit 112 may further comprise a property selection unit for selecting available properties 34 or facts of the report element 24 for use in the expression 28. The expression editing unit 112 may comprise code corresponding to the above functionality such that the code is executable in a reporting application.

FIG. 12 shows an example of a conditional explorer unit 98, in accordance with an embodiment of the conditional layout user interface system 90. The conditional explorer unit 98 comprises a style format receiving unit 114 for receiving a format style 40 or a report element 24 associated with a condition value 30, and a style format application unit 116 for applying the format style 40 selection to the report element 24, or for rendering the report element 24 to a report, when the condition value 30 matches an expression value calculated using the expression 28. The conditional explorer unit 98 may further comprise display units to display selectable variable elements 22 and their condition values 30, selectable report elements 30, and selectable format styles 40. The conditional explorer unit 98 may comprise code corresponding to the above functionality such that the code is executable in a reporting application.

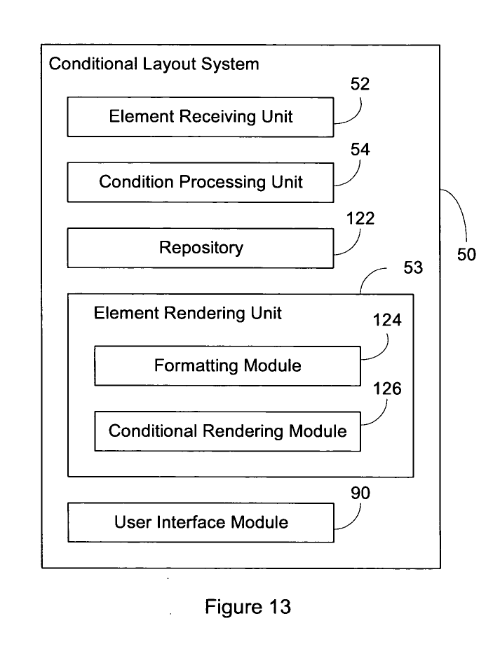

FIG. 13 shows another example of the conditional layout system 50 in further detail. The conditional layout system 50 comprises the element receiving unit 52, the condition processing unit 54, a repository 122 for storing variable elements 22 and report elements 24, an element rendering unit 56 for conditionally formatting and rendering report elements 24, and the user interface module 90. The element rendering unit 56 has a formatting module 124 for conditionally formatting a report element 24, and a conditional rendering module 126 for conditionally rendering a report element 24.

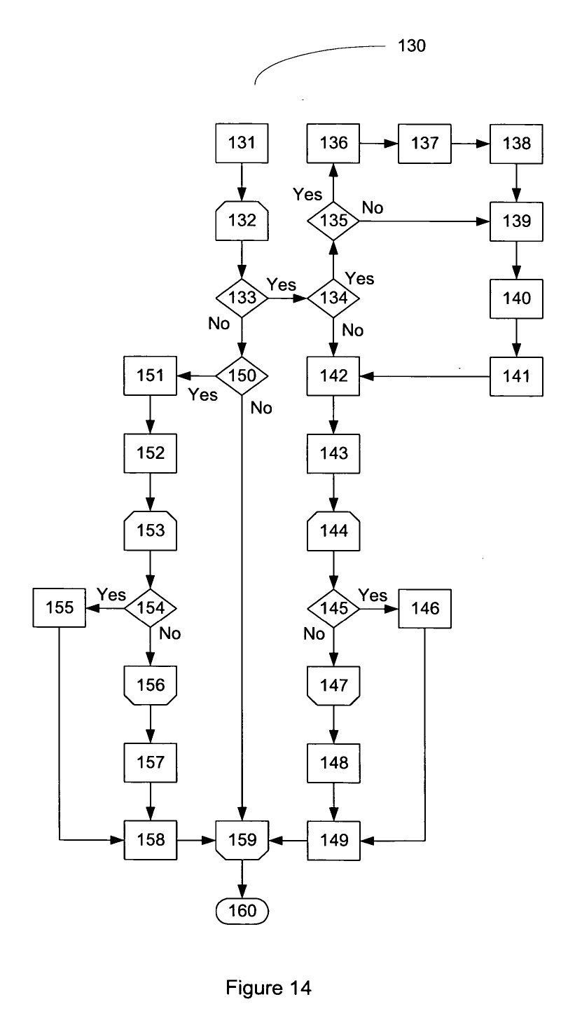

FIG. 14 shows in a flowchart another example of a method of laying out a report (130), in accordance with an embodiment of the conditional layout system 50. The method (130) begins with obtaining or receiving a report (131) to render on a display or printout. For each element in the report (132), steps (133 to 158) are repeated.

If the element in the report is a report element (133), then the next step is step (134). If a request to create a conditional style is received (134) and a request to add a variable element 22 is received (135), then a variable reference 38 is added (136) to the conditional style element 36 of the report element 24. A corresponding variable element 22 is instantiated and a variable type is selected (137). The variable element 22 is now added to a repository (138).

Once the variable element is added to the repository (138), or if a request to add a variable element 22 was not received (135), then a condition value 30 is added to or selected from the variable element 22 (139), a format style 40 of the report element 24 is associated to the condition value 30 (140), and an expression 28 is received (141). A user may generate the expression 28 using properties 34 of the report element 24. Steps (139 to 141) may be repeated for a plurality of condition values 30. The format style may be the default formatting of the report or a format style 40 selected by a user.

Once the condition value 30 is associated with a format style, or if a request to add a variable element 22 is not received (134), then a variable element 22 referenced in the report element 24 is obtained (142). An expression value is calculated using the expression 30 (143) in the variable element 22. For each condition value 30 in the variable element 22 (144), if the expression value matches the condition value 30 (145), then the associated format style 40 is applied to the content of the report element 24 (146). If the expression value does not match any condition value 30 (147), then the default format style is applied to the report element 24 (148). Once a format style 40 is applied (146), or the default format style is applied (148), then the content of the report element 24 is rendered (149) and the next element in the report is processed (150).

If the element to be processed in a report is a conditional block element (150) then a variable element 22 referenced in the report element 24 is obtained (151). An expression value is calculated using the expression 30 (152) in the variable element 22. For each condition value 30 in the variable element 22 (153), if the expression value matches the condition value 30 (154), then the associated report element 24 is selected (155). If the expression value does not match any condition value 30 (156), then the default report element 24 is selected (157). The default report element may include an empty report element if no content is to be rendered by default. Once a report element 24 is selected (155), or the default report element is selected (157), then the content of the selected report element is rendered (158) and the next element in the report is processed (159). Once each element in the report is processed (146), the method (130) is done (160).

### EXAMPLE 1

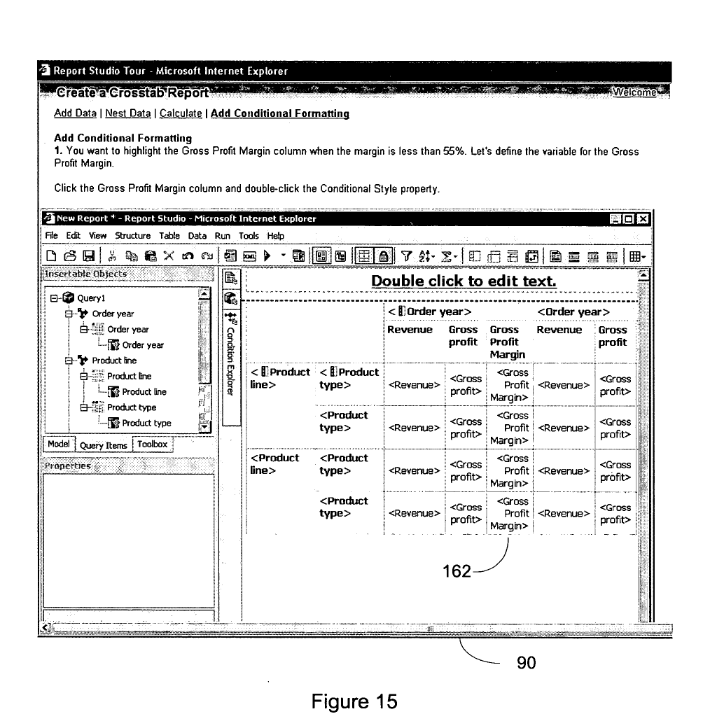

FIGS. 15 to 27 show in screenshots an example of adding conditional formatting to a report. FIG. 15 shows in a screenshot an implementation of a user interface module 90 of FIG. 8. In this example to follow, Gross Profit Margin values in a report will be highlighted when the margin is less that 55%. To define the variable element 22 for Gross Profit Margin, a user clicks on the Gross Profit Margin column 162. The Gross Profit Margin column graphically represents a report element 24.

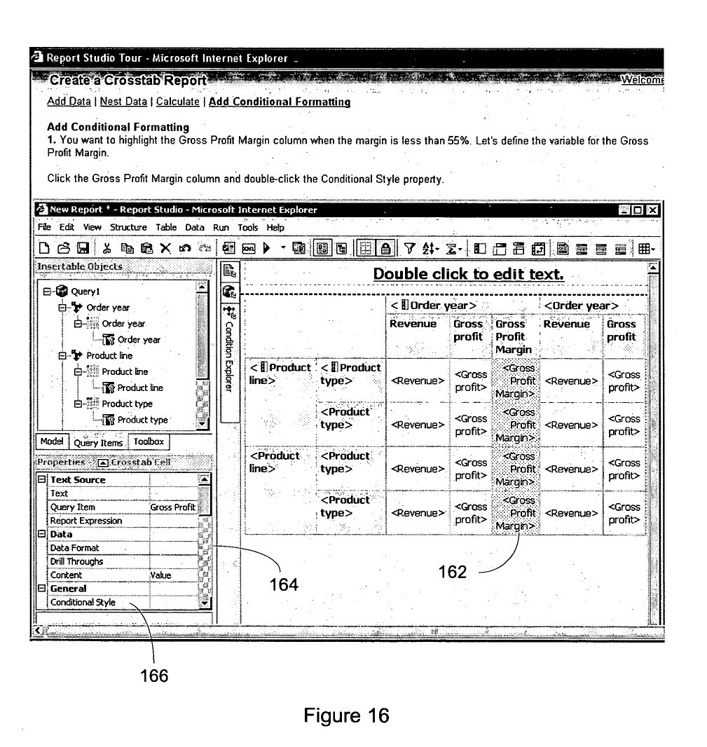

FIG. 16 shows in a screenshot the property 164 selections of the Gross Profit Margin column 162. The property 162 selections correspond with the properties 34 of a Gross Profit Margin report element 24. The conditional style property 166 is double-clicked by a user to get the conditional style dialog unit 92. This conditional style property 166 corresponds with a conditional style element 40 of the Gross Profit Margin report element 24.

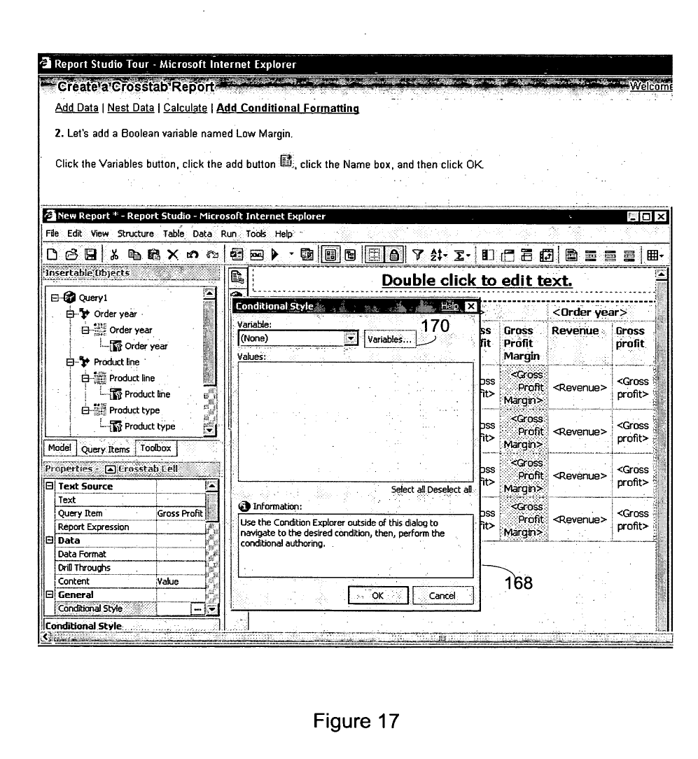

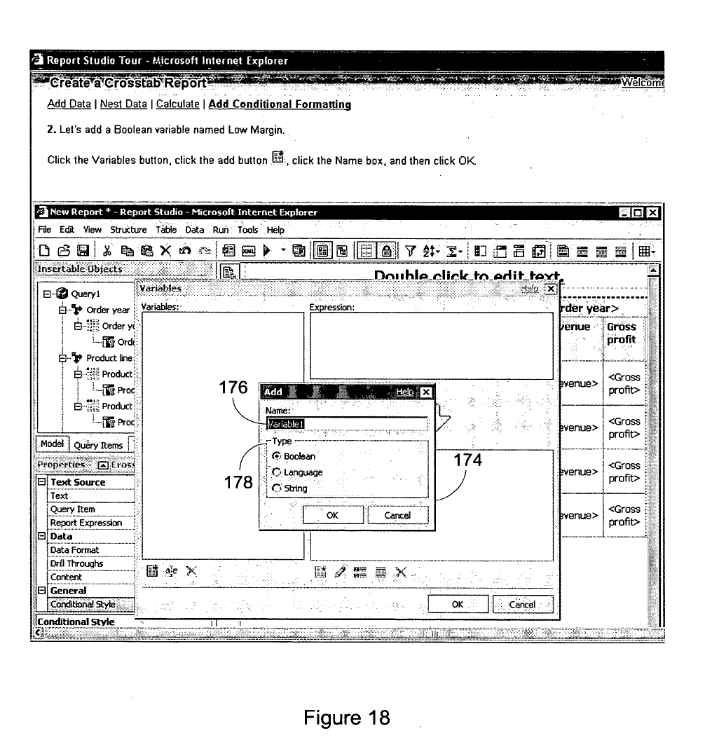

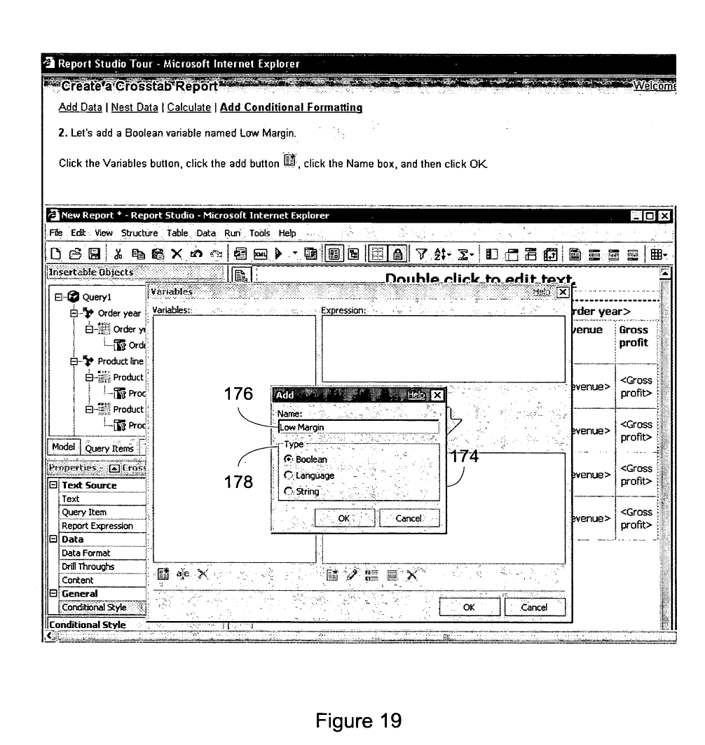

FIG. 17 shows in a screenshot an example of an implementation of the conditional style dialog unit 92 of FIG. 9. In the implementation of FIG. 17, a graphical representation of a conditional style dialog 168 is shown. To add a variable to the conditional style element 40 of the Gross Profit Margin report element 24, a user clicks on the variables button 170, resulting in the Variables dialog 172 and Add dialog 174 shown in FIG. 18. The Variables dialog 172 shown in FIG. 18 is an example of an implementation of the variable dialog unit 94 of FIG. 10. The Name box 176 is used to name a variable element 22. The Type selections 178 are used to select the type of the variable element 22. “Low Margin” is the name and Boolean is the type selected for this variable element 22 as shown in FIG. 19.

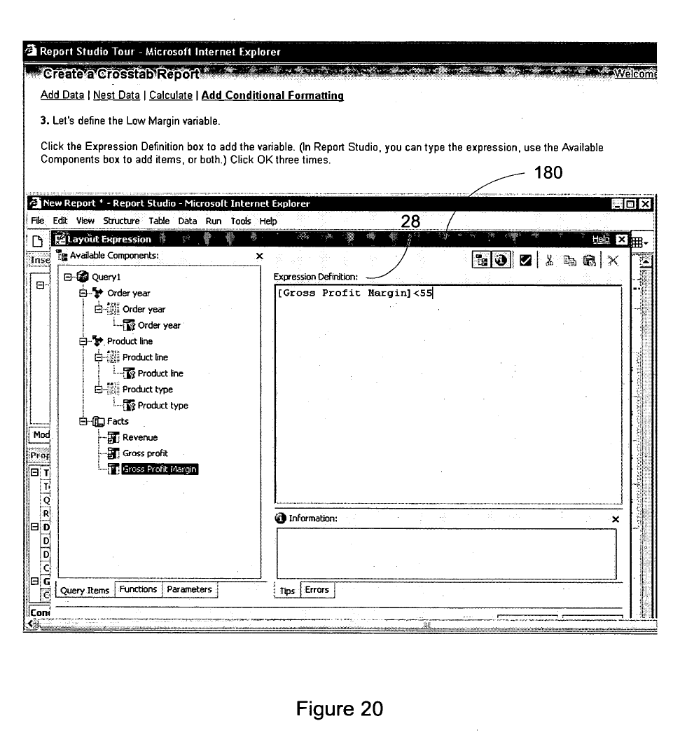

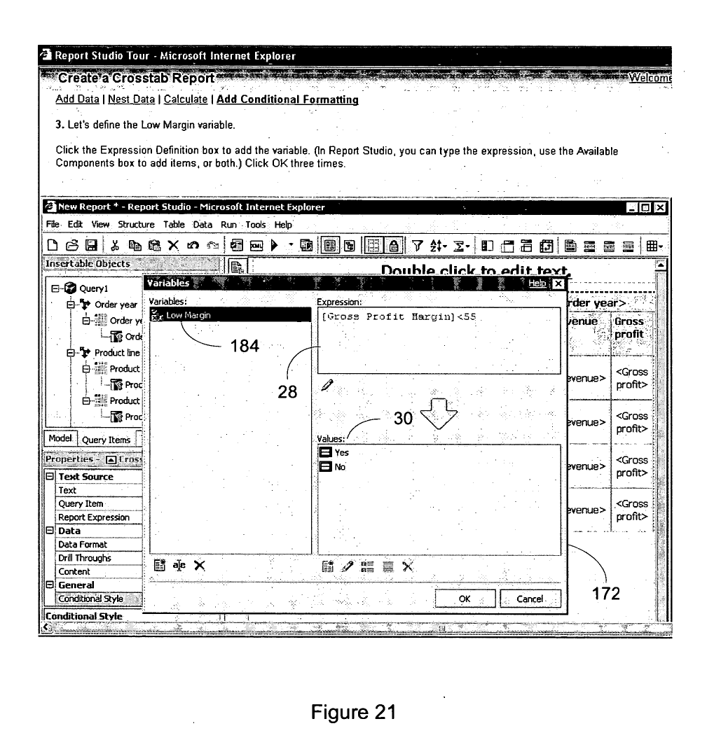

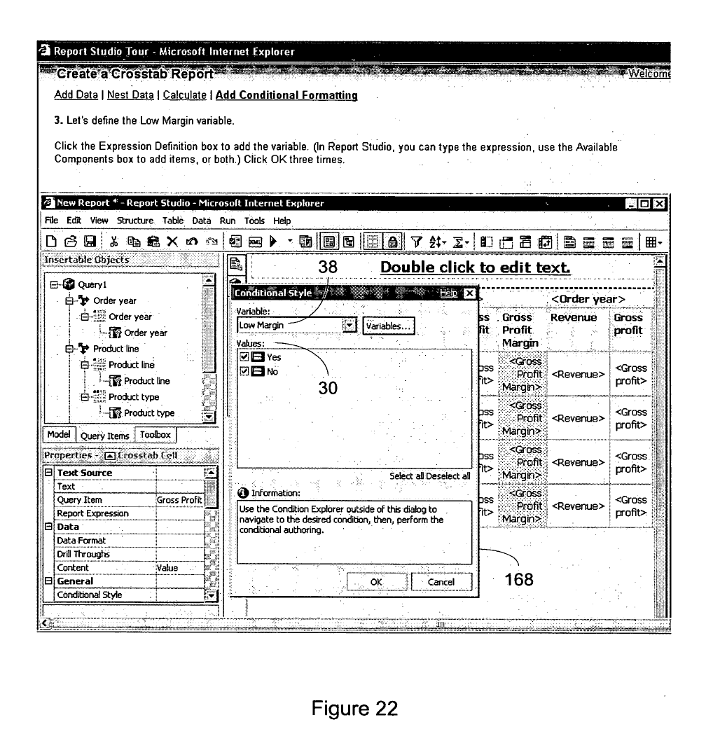

FIG. 20 shows in a screenshot an implementation of the expression editing unit 96 of FIG. 11. In the implementation of FIG. 20, a Layout Expression dialog 180 is shown. The Layout Expression dialog 180 appears once the name and type of a variable element 22 is selected. An expression 28 is entered by a user. In this example, the expression 28 states [Gross Profit Margin]<55. Once the expression 28 is added, the variables dialog 172 appears, as shown in FIG. 21, showing an implementation of a Low Margin variable element 22, its expression 28, and its condition values 30. In the implementation of FIG. 21, a graphical representation 184 of the Low Margin variable element 22 is shown. Once the Low Margin variable element 22 is created, the conditional style dialog 168 appears as shown in FIG. 22. The conditional style dialog 168 shows the variable reference 38 and the condition values 30 of the Low Margin variable element 22. The conditional style element 36 for the Gross Profit Margin report element 24 is now created.

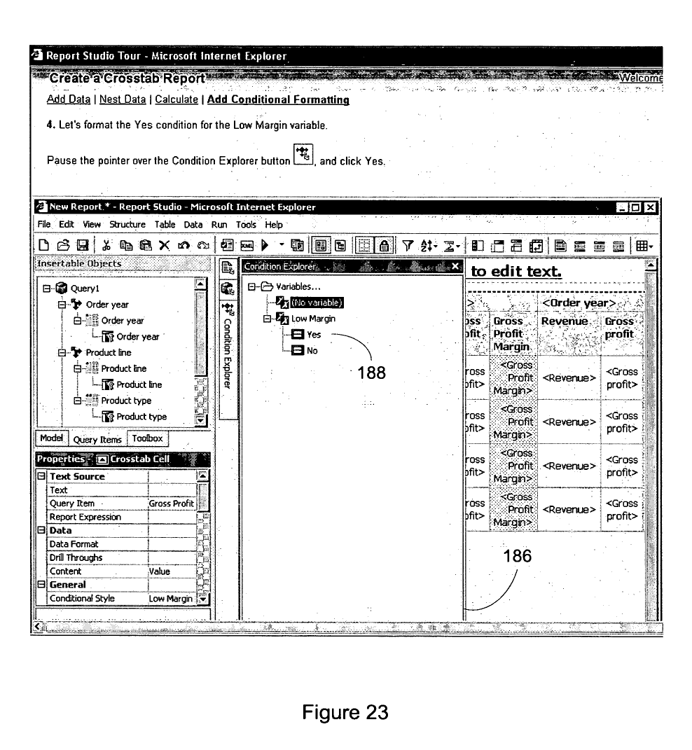

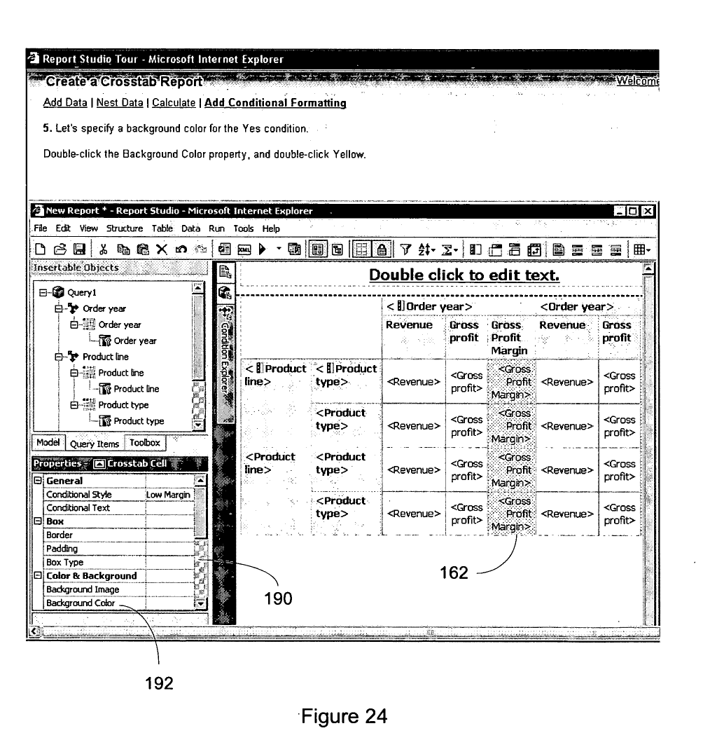

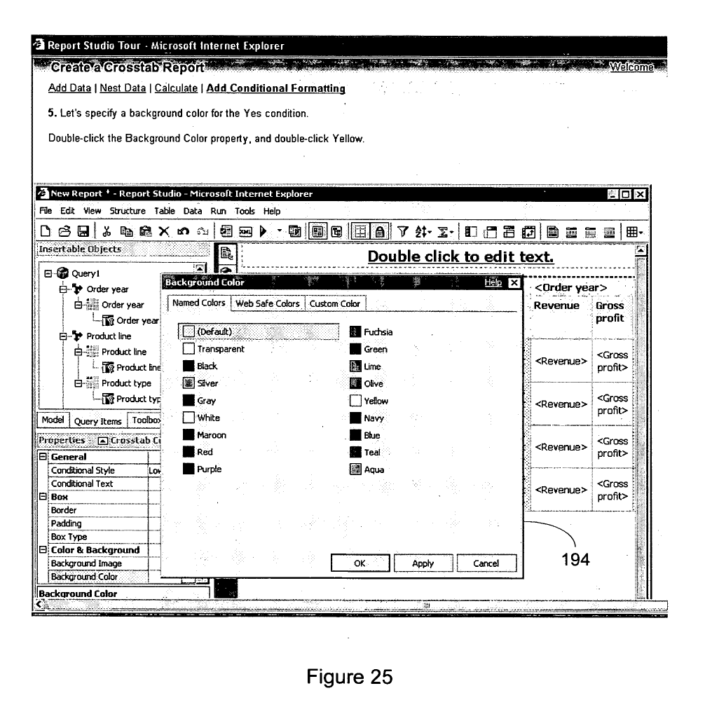

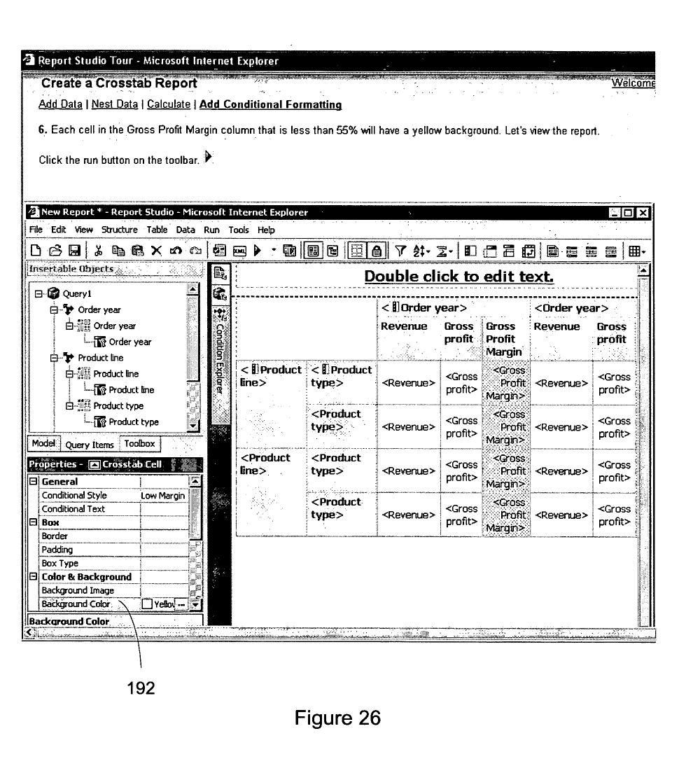

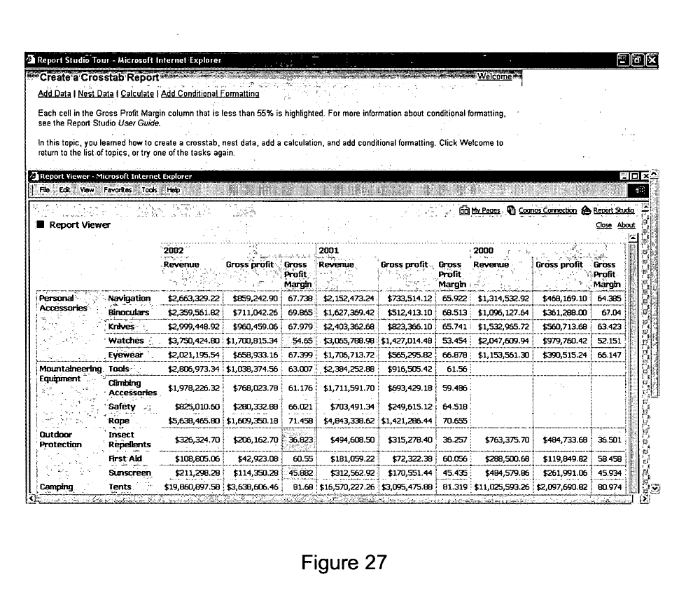

FIG. 23 shows in a screenshot an implementation of the conditional explorer unit 98 shown in FIG. 12. In the implementation of FIG. 12, a conditional explorer dialog 186 is shown. To associate a format style 40 of the Gross Profit Margin report element 24 with the Yes condition value 30 of the Low Margin variable element 22, the conditional explorer dialog 186 is invoked and the Yes value 188 is selected. As shown in FIG. 24, a user may select format style options 40 found in the Gross Profit Margin column 162 conditional style properties box 190. Double-clicking on the Background Color selection 192 brings a Background Color dialog 194 forward, as shown in FIG. 25. In this example, a user selects Yellow and the Background Color property 192 is set to Yellow as shown in FIG. 26. The Yes condition value 188 of the Low Margin variable element 22 is now associated with a Yellow background (or highlight). Running the report will invoke the element rendering unit 56. When a Gross Profit Margin element is rendered, the conditional rendering module provides a yellow background for profit values less than 55%, as shown in FIG. 27.

### EXAMPLE 2

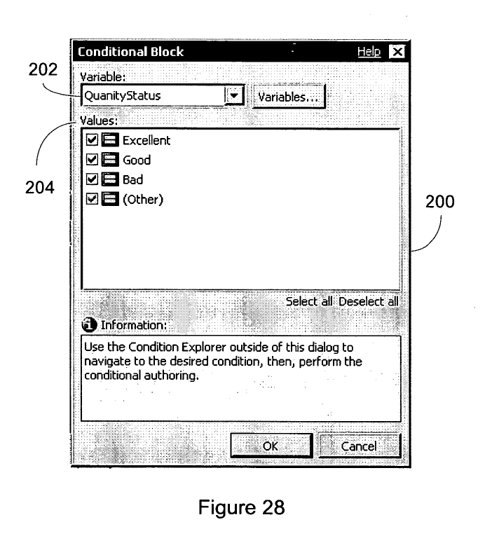

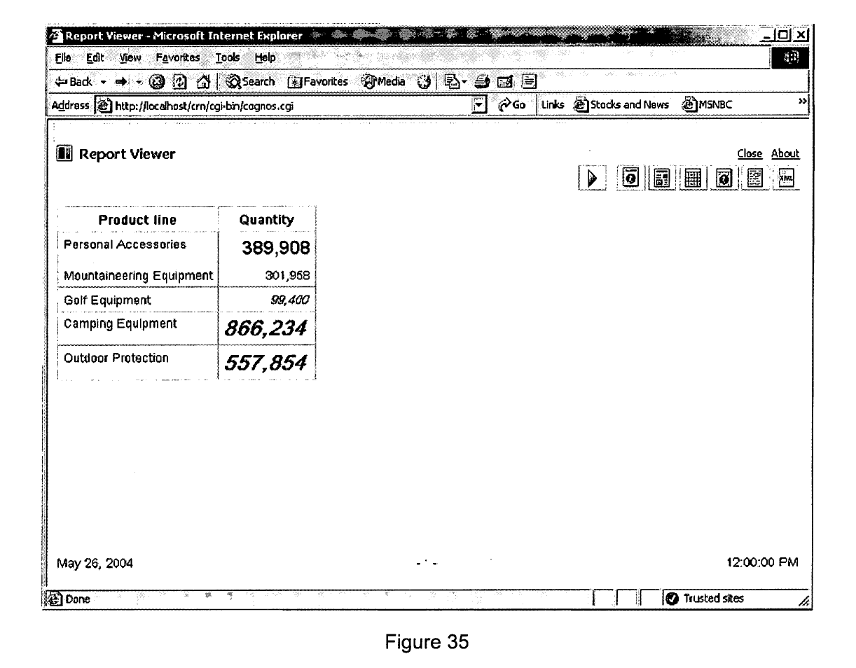

FIGS. 28 to 35 show in screenshots an example of conditionally rendering and conditionally formatting content in a report. FIG. 28 shows in a screenshot an example of a Conditional Block dialog 200 for Quantity corresponding with a conditional block element 44 for quantity status, in accordance with an embodiment of the conditional layout system 50. The variable element 202 for QuantityStatus has four condition values 204.

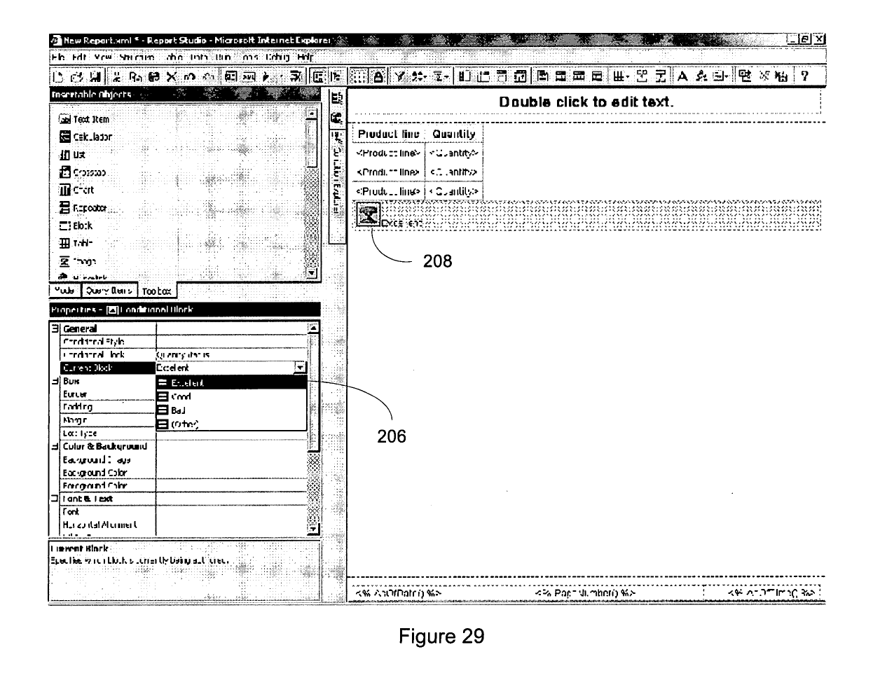

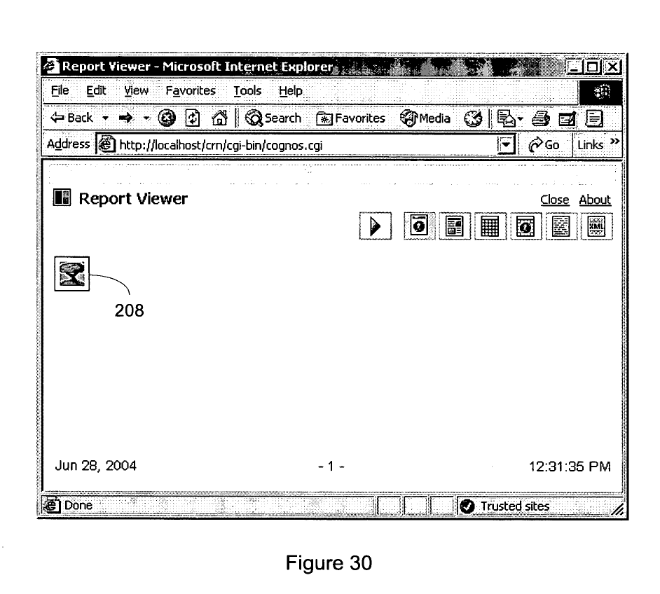

FIG. 29 shows in a screenshot an example of a block to be conditionally rendered, in accordance with an embodiment of the conditional layout system 50. When the Excellent condition value 206 matches an expression value, an image 208 will be rendered. FIG. 30 shows in a screenshot an example of the output of a report showing the image 208.

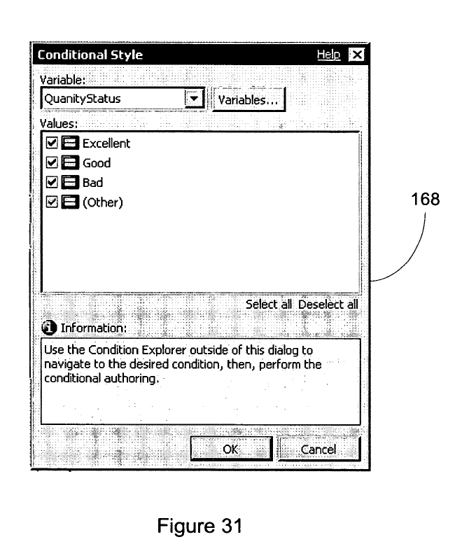

FIG. 31 shows in a screenshot an example of a Conditional Style dialog 168, in accordance with an embodiment of the conditional layout system 50. The Conditional Style dialog 168 corresponds with a conditional style element 36 of a report element 22 for Quantity.

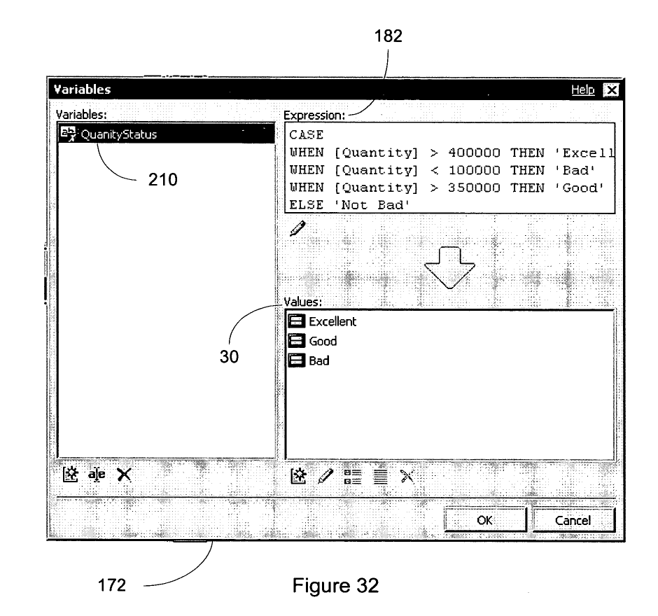

FIG. 32 shows in a screenshot an example of a Variables dialog 172 for the QuantityStatus variable element 22. In FIG. 32, a visual representation of a QuantityStatus variable element 22 is shown. The condition values 30 include Excellent, Good, and Bad. A default condition value is also set to Not Bad.

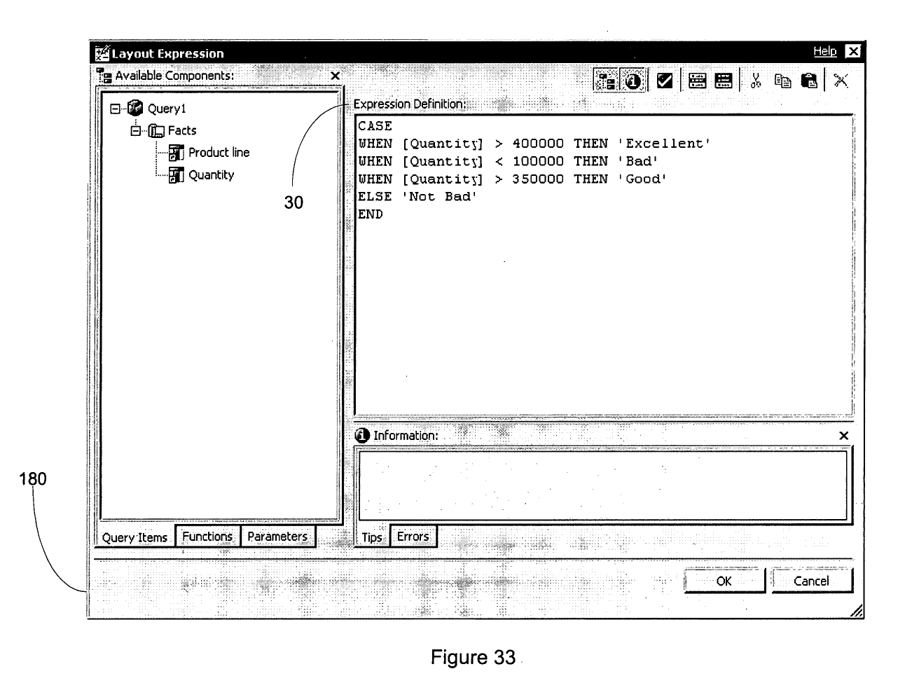

FIG. 33 shows in a screenshot another example of a Layout Expression dialog 180, in accordance with an embodiment of the conditional layout system 50. A user uses this dialog 180 to create or modify the expression 28 for QuantityStatus.

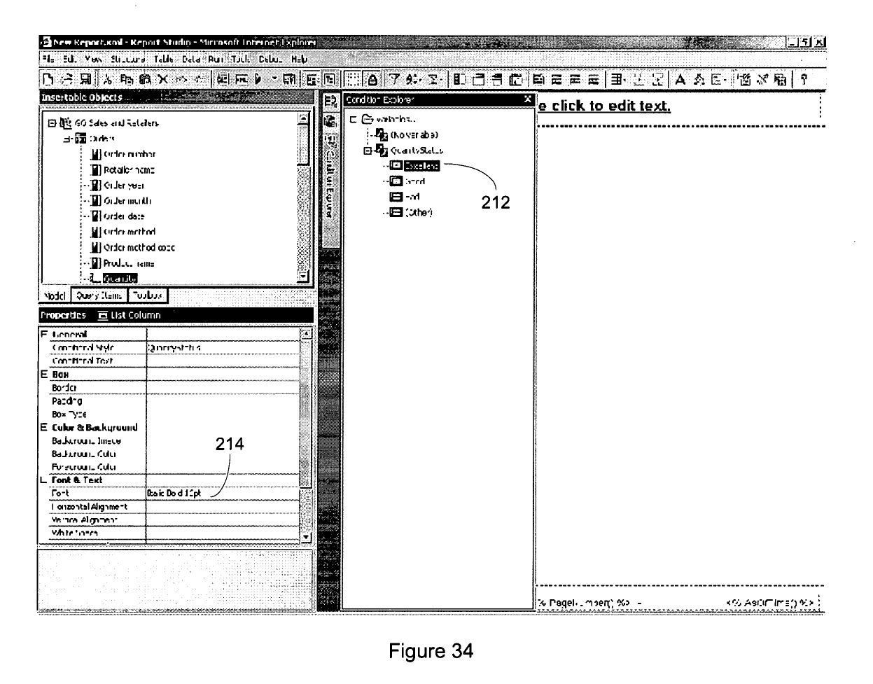

FIG. 34 shows in a screenshot an example of an association between the condition value Excellent and a format style 40 of the Quantity report element 24, in accordance with an embodiment of the conditional layout system 50. In this example, the condition value Excellent 312 is associated with the format style 214 of Italic Bold 16 pt Font. Other associations in this example (not shown), include Good with Bold 14 pt Font, Bad with Italic 10 pt Font, and Not Bad (default) with Regular 12 pt Font. FIG. 33 shows in a screenshot the rendering of a report with the Quantity column conditionally formatted to the fonts associated with the condition values.

The conditional layout systems 30 and 120, user interface module 70, and the methods described above, according to the present invention may be implemented by any hardware, software or a combination of hardware and software having the above described functions. The software code, either in its entirety or a part thereof, may be stored in a computer readable memory. Further, a computer data signal representing the software code that may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A conditional layout system for rendering and formatting content in a report, the conditional layout system comprising:
an element receiving unit for receiving a variable element referenced in a report element, the variable element having an expression;
a condition processing unit for calculating an expression value based upon the expression; and
an element rendering unit for conditionally rendering and formatting report elements based upon the expression value.

2. The conditional layout system as claimed in claim 1, wherein:
the variable element is referenced in a first report element; and
the element rendering unit conditionally renders a second report element in a report, the second report element associated with the expression value.

3. The conditional layout system as claimed in claim 1, wherein the element rendering unit conditionally renders the report element in a format style associated with the expression value.

4. The conditional layout system as claimed in claim 1, further comprising a user interface module, the user interface module comprising:
a conditional style dialog unit for managing a variable element referenced in a conditional block element of a report element;
an expression editing unit for managing an expression of the variable element; and
a conditional explorer unit for associating a condition value of a variable element with a report element.

5. The conditional layout system as claimed in claim 1, further comprising a user interface module, the user interface module comprising:
a conditional style dialog unit for managing a variable element referenced in a conditional style element;
an expression editing unit for managing an expression of the variable element; and
a conditional explorer unit for associating condition values of variable elements with format styles.

6. The system as claimed in claim 5, wherein the conditional style dialog unit includes:
a style format receiving unit for receiving the condition value; and
a style editing unit for associating a format style with a condition value.

7. The system as claimed in claim 6, wherein the conditional style dialog unit further includes a variable dialog unit for creating and managing variable elements, the variable dialog unit having:
a variable receiving unit for receiving variable element management instructions; and
a variable editing unit for creating and managing variable elements in response to the variable management instructions.

8. The system as claimed in claim 6, wherein the conditional style dialog unit further includes a display unit for displaying the variable element namespace, expression and condition values.

9. The system as claimed in claim 5, wherein the expression editing unit includes:
an expression receiving unit for receiving a condition for which a format style should be applied to the report element; and
an expression application unit for calculating an expression value.

10. The system as claimed in claim 9, wherein the expression editing unit further includes a property selection unit for selecting available properties of the report element for use in the expression.

11. The system as claimed in claim 5, wherein the conditional explorer unit includes:
a style format receiving unit for receiving a format style associated with the condition value; and
a style format application unit for applying the format style selection to the report element when the condition value matches an expression value calculated using the expression.

12. The system as claimed in claim 11, wherein the conditional explorer unit further includes display units to display selectable variable elements and their condition values, selectable report elements, and selectable format styles.

13. The system as claimed in claim 5, further comprising a report element selection unit for receiving a report element on which to set a conditional style format.

14. The system as claimed in claim 5, further comprising a repository for storing report elements and variable elements.

15. A method of laying out a report, the method comprising the steps of:
obtaining a variable element referenced in an element of a report, the variable element having an expression;
calculating an expression value based upon the expression; and
conditionally rendering and formatting report elements based upon the expression value.

16. The method as claimed in claim 15, wherein the step of conditionally rendering includes the step of comparing the expression value to a condition value of the variable element.

17. The method as claimed in claim 15, wherein:
the step of obtaining includes the step of receiving the variable element in a first report element; and
the step of conditionally rendering includes the step of conditionally rendering a second report element in a report, the second report element associated with the expression value.

18. The method as claimed in claim 15, wherein the step of conditionally rendering includes the step of conditionally rendering the report element in a format style associated with the expression value.

19. The method as claimed in claim 15, further comprising the step of receiving a request to render a report element.

20. A computer data signal embodied in a carrier wave and representing sequences of instructions which, when executed by a processor, cause the processor to perform a method of laying out a report, the method comprising the steps of:
obtaining a variable element referenced in an element of a report, the variable element having an expression;
calculating an expression value based upon the expression; and
conditionally rendering and formatting report elements based upon the expression value.

21. A computer-readable medium having computer readable code embodied therein for use in the execution in a computer of a method of laying out a report, the method comprising the steps of:
obtaining a variable element referenced in an element of a report, the variable element having an expression;
calculating an expression value based upon the expression; and
conditionally rendering and formatting report elements based upon the expression value.

22. A computer program product for use in the execution in a computer of a conditional layout system for rendering and formatting content in a report, the computer program product comprising:
an element receiving unit for receiving a variable element referenced in a report element, the variable element having an expression;
a condition processing unit for calculating an expression value based upon the expression; and
an element rendering unit for conditionally rendering and formatting report elements based upon the expression value.
